(19) United States
(12) Patent Application Publication
(10) Pub. No.: US 2014/0221181 A1
(43) Pub. Date: Aug. 7, 2014

(54) EXERCISE AND WELLNESS MONITORING METHOD AND SYSTEM

(71) Applicant: Luke Pickett, Melbourne (AU)

(72) Inventor: Luke Pickett, Melbourne (AU)

(21) Appl. No.: 14/241,200

(22) PCT Filed: Aug. 24, 2012
(86) PCT No.: PCT/AU2012/000998

§ 371 Date: Apr. 9, 2014

(30) Foreign Application Priority Data
Aug. 26, 2011 (AU) 2011903441

(51) Int. Cl. G06F 19/00

(52) U.S. Cl. CPC G06F 19/3481
USPC 482/139; 434/247

(57) ABSTRACT

A method, executed by a computer, of treating or preventing musculo-skeletal pain in a person, including: generating identification data representing sources of musculo-skeletal pain, said sources being associated with structures in the musculo-skeletal system; and determining, based on said identification data, and providing exercise data representing one or more exercises to strengthen or loosen said structures.

### FIELD OF THE INVENTION

The present invention relates generally to the field of human health and wellbeing. Particular embodiments provide a method and system of exercise, an apparatus for use in the method and system, and a method and system for wellness monitoring. Particular embodiments find use in the treatment and/or prevention of musculo-skeletal pain.

### BACKGROUND

Computer use and sustained postures have become a part of daily life for both work and leisure. The postures related to long term computer use and repetitive work positions put stress on the human body and consequently cause pain for individuals working or playing in these postures for long periods.

Within an organisation, many individuals may be required to adopt the above-mentioned postures during their working hours and this, in conjunction with other physical or emotional stressors, can adversely affect their physical and/or mental wellbeing. An individual may have an awareness of their wellbeing at any given time, but be unaware of any trends in or causes of, for example, musculo-skeletal pain or low mood.

Typically, individuals suffering musculo-skeletal pain seek treatment from general practitioners or physiotherapists. It is not always convenient for individuals to seek treatment from a health professional, especially when the pain is felt to be relatively minor.

It would be desirable to address or at least partially alleviate the above difficulties or provide a useful alternative.

### SUMMARY OF THE INVENTION

In a first aspect, the invention provides a method, executed by a computer, of treating or preventing musculo-skeletal pain in a person, including:
generating identification data representing sources of musculo-skeletal pain, said sources being associated with structures in the musculo-skeletal system; and
determining, based on said identification data, and providing exercise data representing one or more exercises to strengthen or loosen said structures.

The structures may include muscles, joints, nerves, connective tissue or skin of the musculo-skeletal system.

The method may further include providing a user interface for a user to enter location data representative of one or more regions of the body. The user interface may include an image map with a plurality of clickable or touch-sensitive areas corresponding to at least said regions; and said image map used to generate said location data. The location data may be used to generate said identification data.

The method may further include generating a schedule of exercises. The exercises may be scheduled at regular or irregular intervals. The method may further include triggering an alert at the regular intervals to the person to perform the one or more exercises. In one embodiment, the schedule is user-editable.

The exercises may be selected from the group including: thoracic extension; reverse fly; pectoral stretch; hip flexor stretch; bow and arrow; cervical retraction; lumbar extension; and combined retraction. The selection may be at least partly determined by any impairment of the user, for example due to pain or pathology. Accordingly, the method may include receiving data relating to pain or pathology in order to make the selection of exercises, or to provide predetermined variations of the exercises based on the details of any such impairment.

The method may further include recording wellness data representing one or more wellness parameters for a user. A “wellness parameter”, as used herein, is a qualitative or quantitative indicator of physical or mental wellbeing of a person, and may include, for example, physiological parameters (e.g. resting heart rate, BMI, cholesterol level) and psychological parameters (e.g. a score for a perceived stress level or mood, on a predetermined scale).

The wellness data may be recorded periodically, for example once per day, or multiple times per day at set times.

The wellness data may include data relating to pain, for example, the region or regions of pain and/or the degree of pain in each region.

The wellness data may be generated according to input data from the user. For example, a user interface provided by the method may provide for the user to input data by one or more of: entering a numerical value, selecting a value on a visual analogue scale or a Likert scale, or making a selection from a drop-down list, set of radio buttons or the like. The numerical value(s) or selection(s) may correspond, for example, to a quantitative or qualitative measure of a particular wellness parameter for a particular period such as a working day.

The method may further include maintaining a record of exercises performed by the person. The record of exercises may be used to generate further wellness data.

In one embodiment, the method further includes analysing the wellness data. For example, a numerical or graphical summary or a time series of a particular wellness parameter over a particular period (the last three days, the last week, the last month, etc.) may be generated and displayed to a user via a user interface.

The method may further include retrieving wellness data for a plurality of users, and generating one or more summary statistics for the plurality of users from the wellness data. For example, if the plurality of users work within a particular organisation, the summary statistics may provide useful feedback to the organisation regarding its staff, including for example feedback regarding the impact of the exercises on the wellness of the staff. The wellness data for the plurality of users may also be used to identify wellness issues and to provide, for example, recommendations for treatment or activities to address the wellness issues.

In a second aspect, the present invention provides a computer-implemented method of wellness monitoring, including:
generating a user profile for a user, the user profile being associated with a plurality of wellness parameters for the user;
recording values for at least some of the wellness parameters at a succession of times; and
storing, in the user profile, the values of the wellness parameters at the succession of times.

The method may include recommending, on the basis of the values of the wellness parameters, a course of treatment and/or exercise.

In certain embodiments, the method includes generating a plurality of user profiles associated with respective sets of wellness parameters. Values for parameters within the respective sets may be recorded at the same time for each user profile, or may be recorded at different times.

The method may also include displaying wellness data generated from the values of the wellness parameters. For example, a time series of the values for a particular parameter may be displayed.

The method may include summarising the values of the wellness parameters, for example, by averaging or other statistical summary methods. For example, the values may be averaged over a given time window (week, month, etc.). In one example, the averaged value(s) for one user may be compared against the averaged value(s) of multiple other users, for example against all other users in an organisation, or a division within an organisation. Further, summarised (e.g. average) values of parameters within a particular group of users may be compared against summarised (e.g. average) values within another, non-overlapping, group of users.

The wellness parameters may include at least one of self-rated level of stress/anxiety, duration of sleep, quality of sleep, mood, degree of happiness, perceived back pain, postural alignment (e.g., situational postural alignment, such as sitting position, lifting position, driving position, sleeping posture and the like).

In certain embodiments, the wellness parameters include at least one risk factor. The at least one risk factor may include extrinsic and/or intrinsic risk factors. The risk factors may include, for example, one or more of the following: job description; job history; medical history; medical risk factors.

The method may include recommending, on the basis of the at least one risk factor in combination with at least one other wellness parameter, a course of treatment and/or exercise. In one example, one or more of the user's job description, physical and psychological role requirements, medical and past injury history are assessed in conjunction with wellness data stored in the user profile to recommend an exercise protocol and/or medical treatment and/or wellness intervention. The recommendation optionally includes a referral to a health professional or medical professional. Taking into account the medical and injury history of the user, the wellness data may be used to determine the appropriate exercise, intervention or referral to health professional.

The method may further include receiving user input relating to the values to be recorded. The user input may be received from the user associated with the user profile. Alternatively, the user input may be received from another user, such as an administrator user or another user with sufficiently elevated access permissions to access and edit user profiles. Advantageously, this enables a health professional or a person within an organisation, for example an Occupational Health and Safety Officer, to maintain user profiles by entering wellness data for one or more users.

In a third aspect of the present invention, there is provided a wellness monitoring system, including:
means for generating a user profile for a user, the user profile being associated with a plurality of wellness parameters for the user;
means for recording values for the wellness parameters at a succession of times; and
means for storing, in the user profile, the values of the wellness parameters at the succession of times.

Embodiments of the second and third aspects of the invention may include features of embodiments of the first aspect of the invention.

In a fourth aspect, the present invention provides an exercise apparatus for treating or preventing musculo-skeletal pain in a person, including:
a body having a curved upper surface,
wherein the curved upper surface includes a first portion shaped to support an upper back region of the person, and a second portion shaped to support a lower back region of the person.

Preferably, the first portion and the second portion are joined by a smooth transition region.

The exercise apparatus may further include one or more grooves for placement of a foot, knee, forehead or spine of the person.

In one embodiment, the exercise apparatus further includes a cavity for storage of one or more accessories for use with the exercise apparatus.

The embodiments of the method described above may include at least one exercise, which uses an apparatus of the fourth aspect of the invention.

In a fifth aspect, the present invention provides a computer program product, including a computer-readable medium having instructions stored thereon for controlling at least one processor, wherein the instructions include code for implementing the method of any one of the above embodiments.

In a sixth aspect, the invention provides a method of exercising to prevent or treat musculo-skeletal pain, including performing one or more exercises selected from the group including: thoracic extension; reverse fly; pectoral stretch; hip flexor stretch; bow and arrow; cervical retraction; lumbar extension; and combined retraction.

In a seventh aspect of the present invention, there is provided a method of exercising to prevent or treat musculo-skeletal pain, including performing one or more exercises to mobilise joints or to strengthen or lengthen muscles of the musculo-skeletal system, said exercise or exercises being selected from the group including:
mobilising the Thoracic spine into extension;
mobilising the Thoracic spine into rotation;
strengthening the Lumbar and Thoracic Extensor muscles;
strengthening the Scapular Retractors;
strengthening the Deep Cervical Extensors;
strengthening the Cervical Extensors;
strengthening the Cervical Retractors;
lengthening the Cervical Extensors;
lengthening the Pectorals;
lengthening the Hip Flexors;
self-releasing or massaging the spinal extensors (thoracic and lumbar),
self-releasing or massaging the scapular muscles; and
mobilising the Lumbar spine into extension.

In an eighth aspect, the present invention provides a system for treating or preventing musculo-skeletal pain in a person, including the computer program product of the third aspect of the invention, and/or instructions for performing the method of the fourth or fifth aspects of the invention.

The system may further include the apparatus of the fourth aspect of the invention.

### BRIEF DESCRIPTION OF THE DRAWINGS

Embodiments of the present invention are hereafter described, by way of non-limiting example only, with reference to the accompanying drawings in which:

FIG. 1 is a side view of an exercise apparatus;

FIG. 2 is a top perspective view of the apparatus of FIG. 1;

FIG. 3 is a top perspective view of the apparatus of FIG. 1, viewed from an alternative angle;

FIG. 4 is a bottom plan view of the exercise apparatus;

FIGS. 5(a) to 5(h) illustrate a series of exercises using the apparatus of FIGS. 1 to 4;

FIG. 6 is a side view of a workstation for performing the exercises of FIGS. 5(a) to 5(h);

FIG. 7 is a schematic of a screen shot from a display of a computer running a program module according to one embodiment of the invention;

FIGS. 8 to 11 are flow charts of various processes of the method of an embodiment of the invention;

FIG. 12 is a system of one embodiment of the invention;

FIG. 13 is a system of another embodiment; and

FIG. 14 is a flow chart of a wellness monitoring method.

### DETAILED DESCRIPTION

Embodiments of the method and system of the present invention seek to minimise the extent of, or to substantially prevent, physical injury and psychological illness. Embodiments also seek to optimise performance through enhancing physical health and psychological state of a user of the method and system.

Embodiments of the method and system of the invention find their basis in an analysis of the biomechanics of a person seated at a computer (herein referred to as the ‘seated computer position’), details of which will be set out below. In particular, the biomechanics of the seated computer position has been broken down and the causes of musculo-skeletal pain have been determined on this basis.

A person sitting for long periods will fall into what is commonly called a slumped posture. This position involves an increase in the lumbar flexion, thoracic kyphosis, lower cervical flexion, upper cervical extension and upper cervical protraction. Additionally, the shoulder blades fall into a position of protraction (internal rotation). Individual variations will occur with respect to the degrees of each of the above increases, and variations in shoulder blade position (e.g. downward rotation, winging or tipping) can also exaggerate the shoulder blade changes.

The muscles which usually get tight are generally not endurance-based muscles. As such, they can become overloaded as they are not designed to perform their action for sustained periods as required by the long-term sitter/computer user. By contrast, the endurance muscles, which are geared to hold these positions for long periods, are generally working at a lengthened position and are thus operating at a mechanical disadvantage over long periods.

Furthermore, the long periods of increased muscle tension compress the tissues of the spine (discs or facet joints), thus accelerating the degeneration of these tissues.

The sub-occipital joints (Atlanto-Occipital joint, C1-C2, C2-C3) are stressed with the sustained compression of upper cervical extension and/or protraction. Stresses on these three joints can result in referred pain at the base of the skull, over the sides and over the top of the skull to the forehead, at the eyebrows and behind the eyes. This referred pain is known as a “cervicogenic headache”, i.e. a headache which has its pain origin in the cervical spine.

In addition to the sub-occipital joints, the sub-occipital muscles (e.g. —superior oblique, inferior oblique) can also refer pain over the skull and to the eye and forehead region. These muscles are stressed by the ‘chin-poke’ or protracted position of the upper cervical spine. The upper cervical spine flexors can become tight and also contribute to creating the posture and also become a source of pain.

The lower cervical spine extensor muscles (e.g. —splenius cervicis, longissimus cervicis) are stressed as they are held in a lengthened position whilst also working harder to resist the increased lever arm from the pull of gravity on the head (which is now flexed forward). The stressed muscles become tight and painful.

Similar to the lower cervical extensor muscles, the long lumbar and thoracic extensor muscles (e.g. —erector spinae, longissimus thoracis) have to resist the forward flexion of the thoracic and lumbar spine and correspondingly become tight and sore. This tightness and overactivity also contributes to increased lumbar disc pressure, accelerating the process of lumbar disc bulging.

The muscles attaching to the shoulder blade are generally working as an endurance muscle in the seated computer position, whereas they are designed for intermittent use. A prime example of this is the upper trapezius, which stabilises the shoulder position for upper limb use. This use is repeatedly in a lower range of movement, which means the upper trapezius is fixed in a specific position becoming tight and painful. Additionally, upper trapezius is frequently a muscle which people contract when they are stressed.

Levator Scapulae is another scapular muscle, which frequently becomes stressed with these seated postures. However, generally its involvement in musculo-skeletal pain is due to an abnormal shoulder blade position. More specifically, the shoulder blade is generally downwardly rotated, which means the levator scapulae is being over-recruited to take up the role of upper trapezius during arm elevation.

Rhomboids and middle trapezius become over used due to the shoulder blade protraction that the shoulder blades fall into. They are forced to work whilst on stretch, which causes them to become overactive and painful.

Anteriorly (from the front of the chest wall), the pectoralis major muscle pulls becomes tight and pulls the shoulder blade into a protracted position while the pectoralis minor muscle pulls the shoulder blade into an anterior tilt (tipping).

The hip flexors (e.g. —psoas, iliacus and tensor fascia latae) become tight from being in a shortened position for long periods as the sitting position involves approximately 90 degrees of hip flexion.

The intervertebral discs of the lower cervical, mid to upper thoracic and lumbar spines are all put under stress by spending long periods in flexion. This puts pressure on the anterior (front) region of the disc and decreases the pressure on the posterior (rear) portion of the disc. Over time, this pressure forces the liquid Nucleus Pulposus towards the rear of the disc causing the rear Annulus fibres of the disc to bulge and become a source of pain or apply pressure to surrounding pain sensitive structures (e.g. —nerve roots, spinal cord, cauda equina).

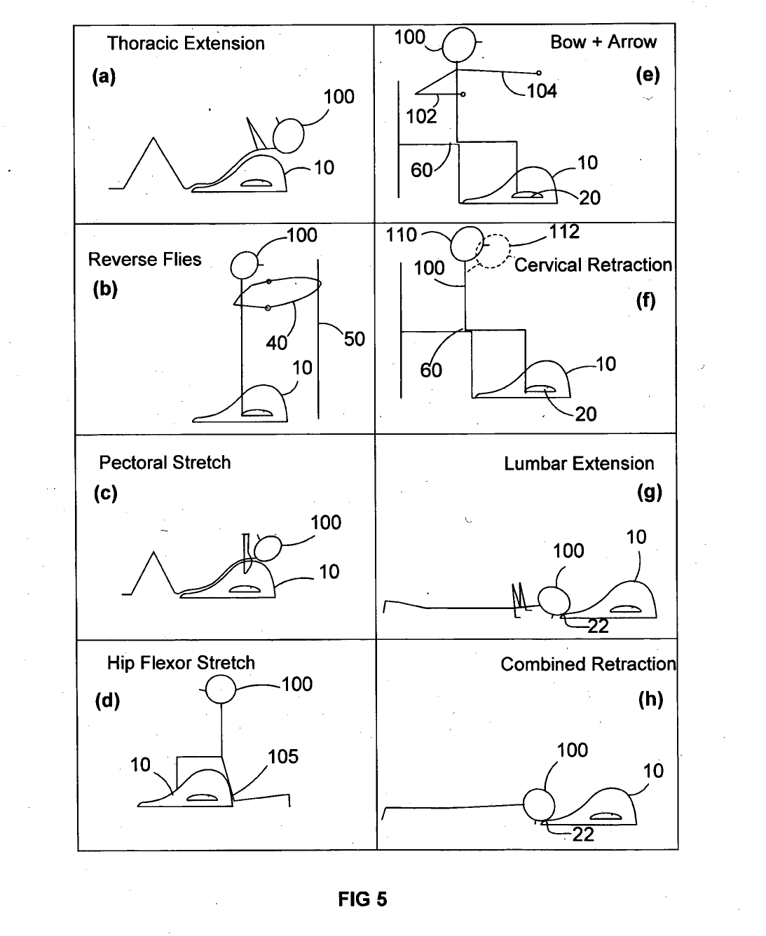

The exercises shown in FIGS. 5(a) to 5(h) and described herein have been developed to address the above problems induced by the seated computer position. The combination of exercises relaxes the tight or overactive muscles, strengthens weak muscles, mobilises stiff joints and affected connective tissue, skin and nerves.

In FIGS. 5(a) to 5(h), the exercises are shown being performed with the assistance of an apparatus 10 which will be described in more detail below.

In FIG. 5(a) a person 100 is shown on their back, and stretched over the apparatus 10. The upper back is supported by a first portion 12 and the lower back by a second portion 14 of the apparatus 10, and the spine is located approximately in the position of spine groove 24. To perform the thoracic extension exercise, the person 100 supports the neck and allows the head and shoulders to tilt backwards over the upper portion 14. This provides thoracic extension, which mobilises the stiff thoracic spine that is positioned in flexion whilst in long periods of sitting or computer use. Mobilising the thoracic spine into extension alleviates the pain on structures stressed from long periods of flexion (e.g. —thoracic facet/zygopophyseal joints capsules) and enables the thoracic spine extensors to work more efficiently against gravity and thoracic joint stiffness from being flexed for long periods. This decreases the pain which is caused by these muscles being over-recruited to work against gravity and reduces the associated increased lever arm of body weight due to increased lumbar and thoracic spine flexion with slumped sitting, along with joint stiffness.

In the Reverse Fly Exercise of FIG. 5(b) the person 100 stands with feet placed in foot grooves 20 and holding a resistance band 40, which is stretched around a solid support 50, for example a pole. The arms start in shoulder flexion (approximately 80 degrees) with the elbows slightly flexed. Maintaining this slightly flexed elbow position, the arms are horizontally extended against the band of resistance, until the arms sit in approximately 80 degrees of abduction. The exercise is performed slowly and with control. This strengthens the scapular stabilisers, more specifically, the scapular retractors. Additionally, this action increases the blood flow to the region to provide oxygen/nutrients and helps remove metabolites/waste products from the isometrically contracting scapular muscles—providing relief from muscle ache.

In the Pectoral Stretch of FIG. 5(c) the person 100 lies over the apparatus 10, with the lumbar spine, thoracic spine and head supported. The arms are then abducted to 90-135 degrees and, then with the weight of gravity, horizontally extended (anatomical description) to create a stretch of the pectoral muscles. Individual heads of the pectoralis major muscle can be biased by range of abduction (stated above).

In the Hip Flexor Stretch of FIG. 5(d) the person 100 places their knee in the knee groove 105 of the apparatus 10. The knee groove provides a stable support for the person 100 and offloads the pressure on the patella (knee cap) whilst it bears weight during the stretch. The opposite/contralateral foot is placed on the floor to the side of the apparatus 100 while the leg supports and balances the body. The person 100 then posteriorly tilts the pelvis and keeps the lumbar spine in a neutral position. This minimises any compression or increased load on the lumbar facet (zygopophyseal) joints. Whilst maintaining this neutral spine and posteriorly tilted pelvis, the whole body (spine, head, shoulders and upper limbs) moves forward to create a stretch in the hip flexors (i.e. —iliopsoas).

In the Bow and Arrow Exercise of FIG. 5(e) the person 100 sits on a chair 60 with the apparatus 10 between their feet. The apparatus 10 ensures that the patient maintains hip stability on the chair, which ensures that thoracic rotation is obtained during the exercise and hip translation or rotation (in the transverse plane) is prevented. The person 100 sits with appropriate seated posture and the arms 102/104 start below shoulder height (75-85 degrees of shoulder flexion). From this start position, arm 104 reaches forward in the same plane as the arm 102 reaches out behind—attempting to distance the finger-tips of arm 104 as far as possible from the elbow of arm 102. The spine acts as the axis of thoracic rotation during this movement. This mobilises the thoracic spinal joints (e.g. —zygopophyseal/facet joints, costo-vertebral joints, costo-transverse joints and possibly the costo-chondral joints).

In the Cervical Retraction Exercise/Stretch of FIG. 5(f) the person 100 is seated (as per the Bow and Arrow exercise) on a chair 60 with the apparatus 10 between their feet. In this exercise the apparatus 10 acts as reminder or prompt for appropriate seated posture, which will be carried over into seated use. The person 100 sits with an appropriate posture and the head is retracted via upper cervical spine flexion to neutral and lower cervical spine extension to neutral. The upper cervical extensors are put on stretch with this retraction action and muscle tension is relieved from these potential causers of neck pain and headache referral.

In the Lumbar Extensions Exercise of FIG. 5(g) the person 100 lies prone with their forehead on the forehead groove 22 of apparatus 10. The forehead groove enables the person 100 to lie prone without pressure on their nose. The hands are placed in a ‘push-up’ position and whilst relaxing the back muscles as best as possible and utilising predominantly force from the arms the person 100 pushes the upper body off the ground to extend the lumbar spine whilst keeping the pelvis on the ground. A specific height is required to ensure that the lumbar spine extends but does not extend so far as to stress the lumbar spine facet joints with too much lumbar extension. Holding for three seconds and then lowering back down will create an extension moment at the lower lumbar discs and offload the posterior annulus of the disc. It is thought that the offloading occurs by providing high pressure at the posterior portion of the disc and low pressure at the anterior portion of the disc and ‘massaging’ the nucleus pulposus anteriorly within the disc.

In the Combined Protraction Exercise of FIG. 5(h) the person 100 lies prone with the forehead in the forehead groove 22 of the apparatus 10 (as per the Lumbar Extensions Exercise). Lying prone with the arms by each side the person 100 retracts both shoulder blades together and then retracts the head out of the groove. Holding this position for a specified period (3 to 5 seconds) and then lowering the head and then the shoulder blades completes the exercise. This action, against gravity, strengthens the muscles required for endurance sitting, especially the long lumbar and thoracic extensors, the lower cervical extensors, shoulder blade retractors and the upper cervical spine retractors.

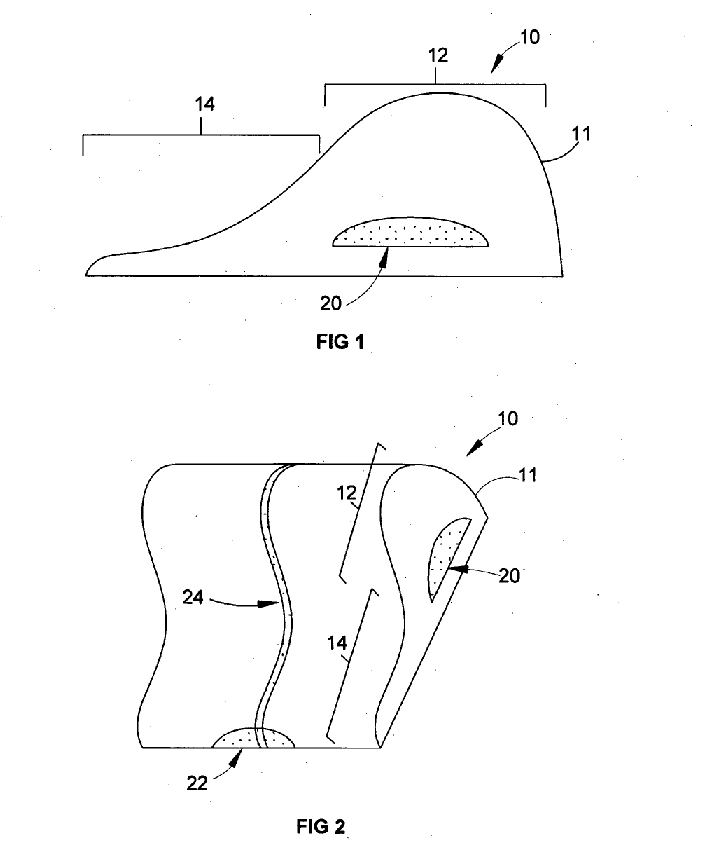

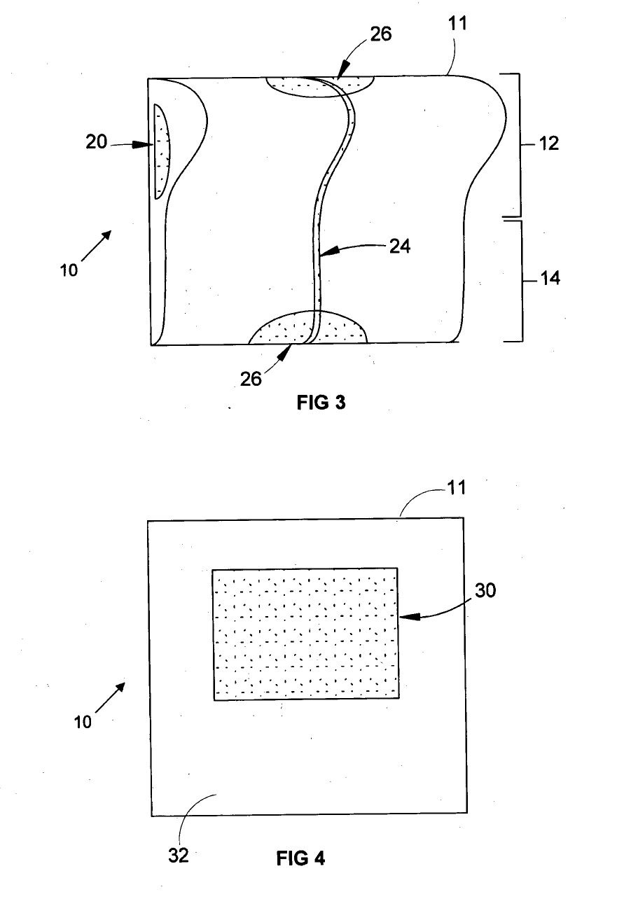

Turning now to FIGS. 1 to 3, there is shown an exercise apparatus 10 including a body 11 having a curved upper surface which includes a first portion 12 shaped to support an upper back region of a person, and a second portion 14 shaped to support the lower back region of the person. The first portion 12 and second portion 14 are joined by a smooth transition region.

The body 11 may be formed from a plastics material, preferably a hard plastics material, for example by injection moulding. It may also be formed of a foam material.

Advantageously, the lower back support provided by second portion 14 results in improved thoracic extension (when a user lays on the apparatus 10) over known apparatus such as cylindrical foam rollers. Thoracic extension may be performed safely without creating undue stress on the Lumbar spine whilst supporting it with the graduated concave to convex design shown in FIGS. 1 to 4.

The width of first portion 12 is preferably sufficient to accommodate the shoulder width of a typical person.

The exercise apparatus 10 includes grooves 20, 22, 24 and 26 for placement of various body parts of the user when performing exercises. Foot grooves 20 may receive the feet of the user when he or she is in the seated or standing positions, thereby assisting the user to maintain correct posture and also provide a physical prompt to maintain correct posture when placed between the feet during extended periods of seated or standing positions. Forehead groove 22, spine groove 24 and knee groove 26 may be used in various exercises as described above.

The spinal groove 24 enables the user to freely extend over barrel without compressing the spinous processes of the lumbar and thoracic spines which are anatomically superficial and will cause the user pain if thoracic extension is performed directly over/on a hard convex surface.

The foot grooves 20 enable the user to maintain hip position during the bow and arrow, standing posture during the reverse flies, and a seated posture reminder during the cervical retraction, and during daily seated activities or computer use.

The forehead groove 22 provides a forehead support for combined protraction and lumbar extensions and enables the user to lie prone without compression of the nose.

The knee groove 26 provides a position for the knee to be supported and offload the patella (knee cap) to avoid irritation and compression of the knee cap whilst performing the hip flexor stretch

As shown in FIG. 4, the lower surface 32 of the apparatus 10 includes a cavity 30 for storage purposes, for example for storing accessories used with the apparatus (e.g. —resistance cord, spikey/self massage ball, foam mat).

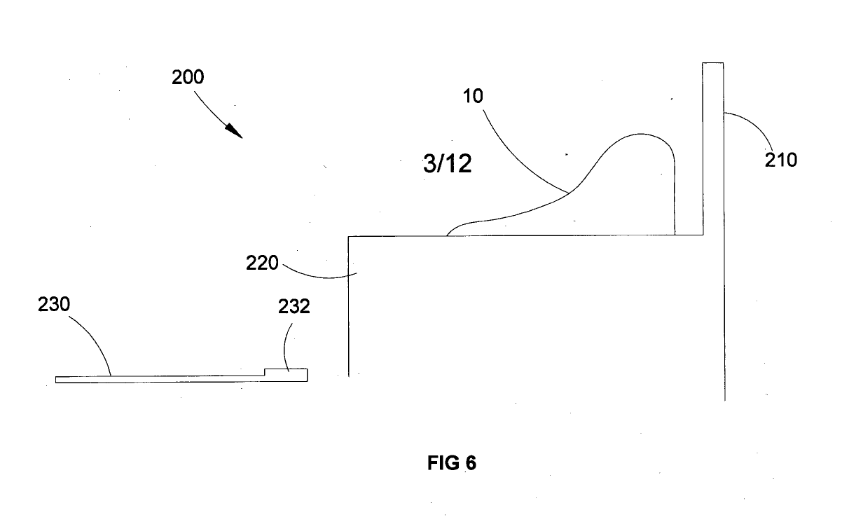

FIG. 6 shows a purpose-built workstation 200 for performing the exercises shown in FIGS. 5(a) to 5(h). The workstation includes an exercise apparatus 10 and an elevated bench 220 for performing seated exercises such as the bow and arrow of FIG. 5(e) or the cervical retraction of FIG. 5(f). The workstation also includes a pole 210 for attachment of a resistance band 40 as shown in FIG. 5(b). Also included is an exercise mat 230 including a forehead pad 232, which could be used for performing the lumbar extension of FIG. 5(g) or the combined protraction exercise of FIG. 5(h).

The combination of the exercise apparatus 10 and exercises 5(a) to 5(h) enables the user to:
Mobilise the Thoracic spine into extension
Mobilise the Thoracic spine into rotation
Strengthen/Exercise the Lumbar and Thoracic Extensors muscles
Strengthen/Exercise the Scapular Retractors
Strengthen/Exercise the Deep Cervical Extensors
Strengthen/Exercise the Cervical Extensors
Strengthen/Exercise the Cervical Retractors
Lengthen the Cervical Extensors
Lengthen the Pectorals
Lengthen the Hip Flexors
Mobilise the Lumbar spine into extension
Offload Lumbar disc pressure
Provide a reminder of postural position (e.g., by placing the apparatus between their feet whilst in the seated computer position).

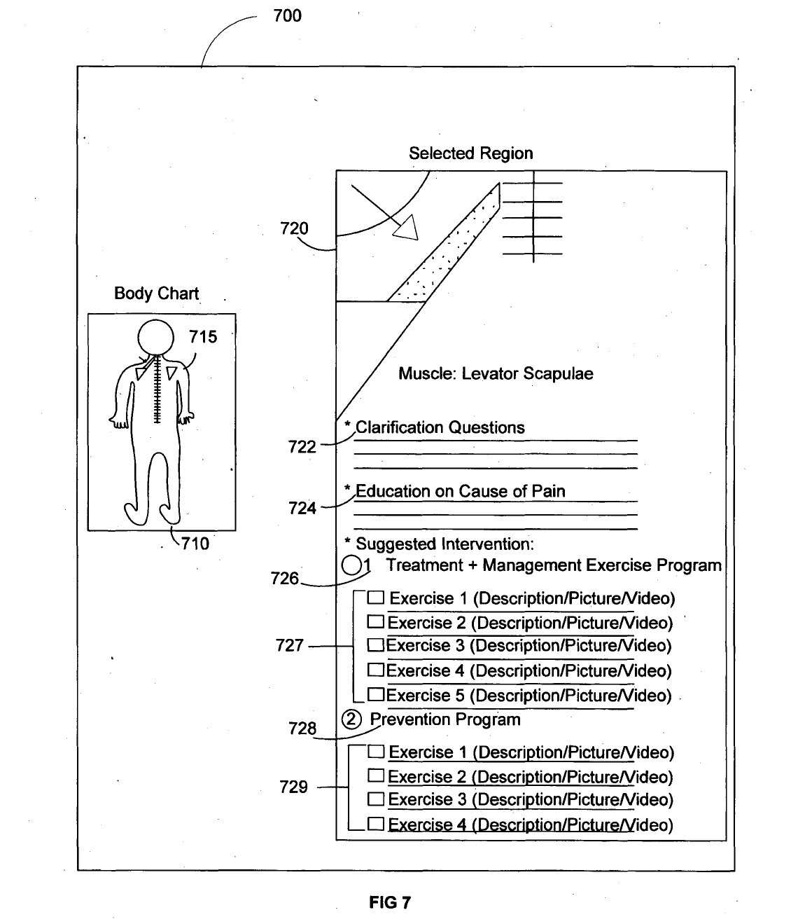

Turning now to FIGS. 7 to 14, there are described embodiments of a method and system for wellness monitoring, and a method and system for treating or preventing musculo-skeletal pain in a person.

The system and method may be implemented on a standalone computer 1200 based on a computer, such as a 32 or 64 bit Intel architecture computer produced by Lenovo Corporation, IBM Corporation, or Apple Inc. Alternatively, the computer 1200 may be a mobile computing device such as smartphone, tablet, PDA etc such as the iPhone and iPad produced by Apple Inc. The data processes executed by the computer system 1200 are defined and controlled by computer program instruction code and data of software components or modules 1250 stored on non-volatile (e.g. hard disk) storage 1204 of the computer 1200. The processes performed by the modules 1250 can, alternatively, be performed by firmware stored in read only memory (ROM) or at least in part by dedicated hardware circuits of the computer 1200, such as application specific integrated circuits (ASICs) and/or field programmable gate arrays (FPGAs).

The computer 1200 includes random access memory (RAM) 1206, at least one microprocessor 1208, and external interfaces 1210, 1212, 1214 that are all connected by a system bus 1216. The external interfaces include universal serial bus (USB) interfaces 1210, a network interface connector (NIC) 1212, and a display adapter 1214. The USB interfaces 1210 are connected to input/output devices, such as a keyboard and mouse 1218. The display adapter 1214 is connected to a display device, such as an LCD display screen 1222. The NIC 1212 enables the computer 1200 to connect to a communications network 1310. The network 1310 may include one or a combination of existing networks, such as a LAN, WAN, the PSTN, the Internet, mobile cellular telephone networks, etc. The computer 1200 includes an operating system (OS) 1224, such as Microsoft Windows, Mac OSX, Linux, iOS or Android. System 1200 also includes database management software having structured query language (SQL) support such as MySQL, available from http://www.mysql.com, which allows data to be stored in and retrieved from an SQL database stored on non-volatile storage 1204. The modules 1250 all run on the OS 1224, and include program code written using languages such as C, Ruby or C#.

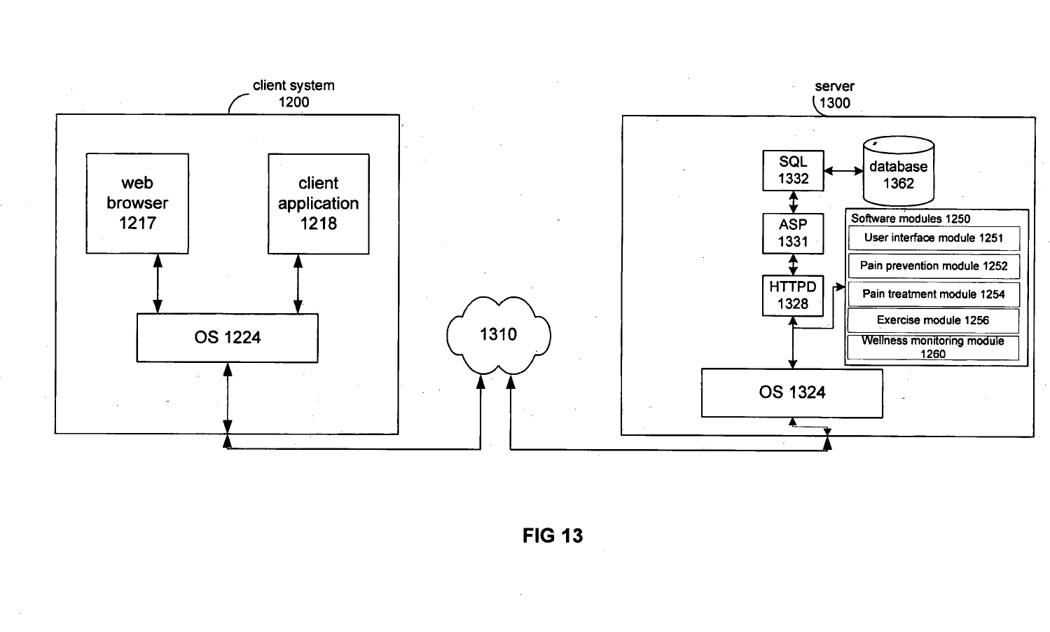

In an alternative embodiment, shown in FIG. 13, the system and method are implemented in a client-server architecture. In this embodiment, the computer 1200 is a client computing device which connects to a server 1300 over the network 1310. In this implementation, client browser 1217 can be used to communicate with server system 1300 to request content therefrom, in the form of one or more web pages provided as program code executable by the browser application 1217, possibly in conjunction with client applications 1218.

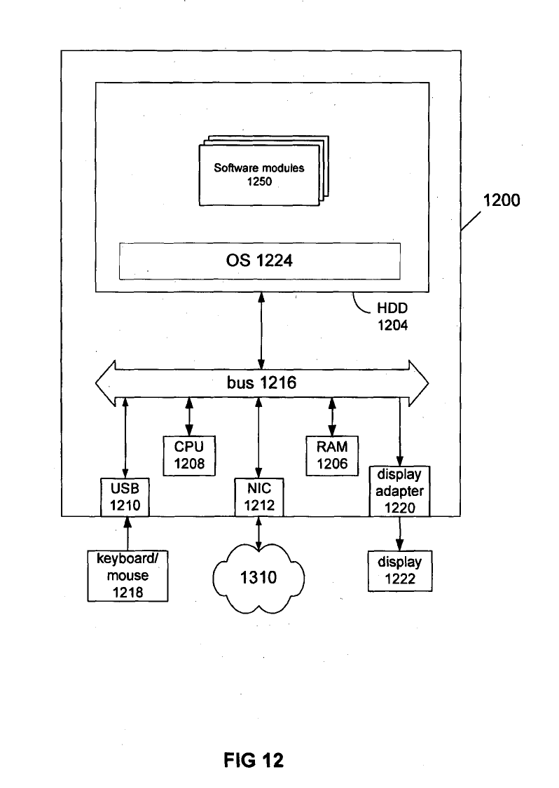

The server 1300 may be a desktop computer system having an architecture similar to that of computer system 1200 shown in FIG. 12, for example. The server 1300 includes a plurality of software modules, including: an operating system (OS) 1324 (e.g., Linux or Microsoft Windows); web server software 1328 (e.g., Apache, available at http://www.apache.org); scripting language modules 1331 (e.g., personal home page or PHP, available at http://www.php.net, or Microsoft ASP); and structured query language (SQL) modules 1332 (e.g., MySQL, available from http://www.mysql.com), which allow data to be stored in and retrieved/accessed from an SQL database 1362.

Together, the web server 1328, scripting language 1331, and SQL modules 1332 provide the computer system 1300 with the general ability to allow users of the Internet 1310 with computing devices equipped with web browser software to access the computer system 1300 and in particular to provide data to and receive data from the database 1362. The specific functionality provided by the system 1300 to such users is provided by scripts accessible by the web server 1328, including the software modules 1250 implementing the processes 800, 900, 1000, 1100, 1400, and also any other scripts and supporting data, including markup language (e.g., HTML, XML) scripts, PHP (or ASP), and/or CGI scripts, image files, style sheets, and the like.

Referring now to FIGS. 7 to 11, there will be described an embodiment of a method of treating or preventing musculo-skeletal pain.

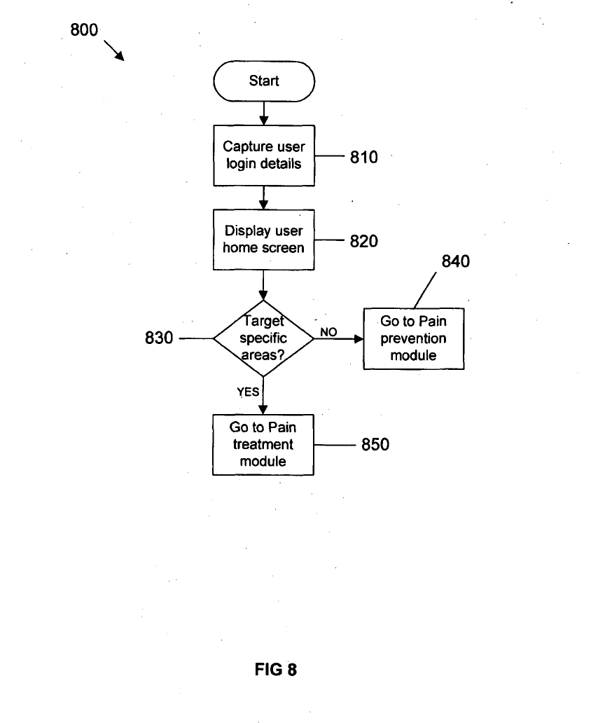

In the method of treating or preventing musculo-skeletal pain 800 of FIG. 8, user interface module 1251 interacts with web browser 1217 to prompt a user to provide login details at step 810. The user interface module 1251 then causes web browser 1217 to display the user's home screen on display 1222, at step 820. The home screen is generated based on the user's profile which is stored in database 1362 and may include one or more areas for the user to input qualitative or, quantitative data representative of various wellness parameters. For example, the user interface module 1251 may cause browser 1217 to prompt the user to answer a series of questions relating to the following wellness parameters, in order to generate and record wellness data:
Pain
   Degree
   Region
Exercise Protocol Adherence
Happiness
Perceived Stress Levels
Sleep
   Quality
   Hours
Self rated work performance

Wellness parameters can also include general medical and health information, which can be monitored. For example:
Resting Heart Rate
Blood Pressure
BMI
Cholesterol
Psychological Parameters
Case Specific Values—(e.g. Blood Glucose for Diabetics, etc)

The input or generated wellness data are stored in the user's profile in database 1362 and are available to modules 1250 for various purposes including generating a new exercise schedule or modifying an existing stored exercise schedule. The wellness data may also be used to trigger other events within modules 1250, such as a display event, which causes browser 1217 to prompt the user to seek advice from a medical practitioner or health professional, such as a psychologist, physiotherapist, nutrionist or exercise physiologist. In some embodiments, modules 1250 may cause the display of links to educational resources accessible via network 1310, for example resources located at a World Wide Web server. The educational resources may include information on a wide range of health-related topics, such as nutrition, causes of and treatment for pain, benefits of exercise, stress relief strategies and the like.

The modules 1250 may include a wellness monitoring module 1260 for monitoring daily values of the wellness parameters, and providing feedback and/or an analysis of an individual's wellness based on those values. The monitoring may be based on user input of values for the above parameters, as described above. For some parameters, for example Exercise Protocol Adherence, the monitoring may be automated. The modules 1250 may also include a data capture module (not shown) which allows for upload of data from devices such as heart rate monitors and the like. The upload may be initiated upon the system 1200 detecting when any such device is connected, for example via USB interface 1210 or wirelessly via a RF (e.g., Bluetooth) or infrared connection. In other embodiments, an interface device configured to communicate with the heart rate monitor or other device may be coupled to system 1200, for example via USB interface 1210, and may provide data to the data capture module. The uploaded data may be allocated as values for one or more wellness parameters by the data capture module or by another of modules 1250.

Referring again to FIG. 8, the user interface module 1251 may then cause browser 1217 to prompt the user, at step 830, as to whether they wish to undertake a pain prevention program (step 840) or to target one or more specific areas (pain treatment program, step 850).

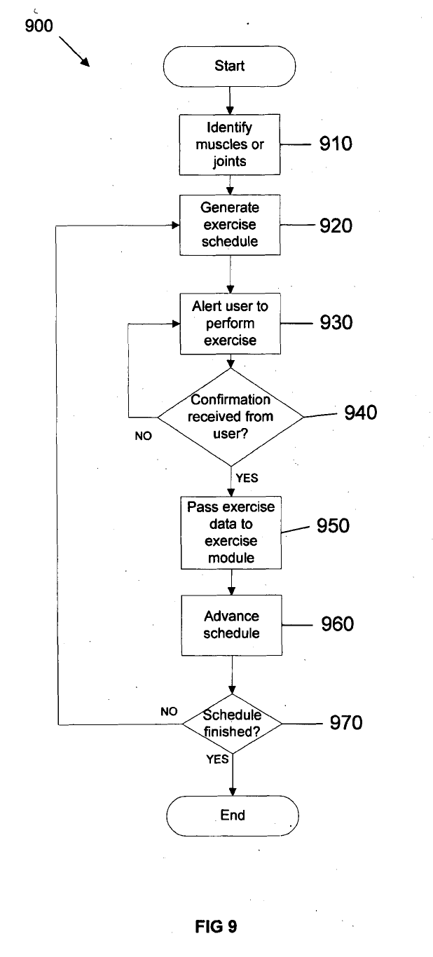

A flow chart for a pain prevention process 900 effected by pain prevention module 1252 is shown in FIG. 9. Module 1252 first generates identification data corresponding to structures, which are potential sources of musculo-skeletal pain, at step 910. For a general prevention program these will be predetermined. For example, for prevention of pain due to computer use, the structures to be targeted may include the sub-occipital joints, lower cervical spine extensor muscles, long lumbar and thoracic extensor muscles, the levator scapulae, the rhomboids, middle trapezius, pectoralis major and hip flexors.

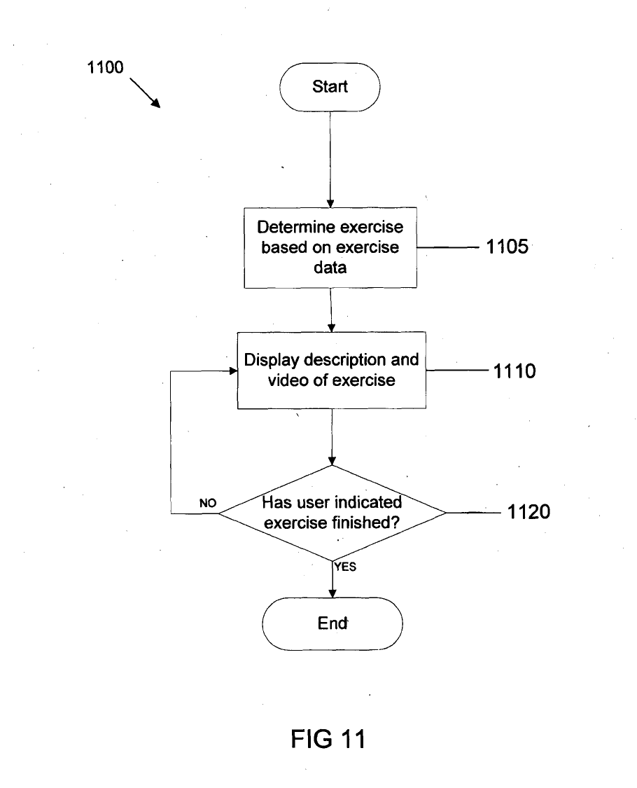

The pain prevention module 1252 then generates a schedule of exercise data including the type of exercise, the number of repetitions or the duration of each exercise, and the time at which each exercise is to commence. The exercises are chosen by the pain prevention module 1252 to target the identified muscles/joints, at step 920. When the schedule begins, the pain prevention module 1252 cooperates with user interface module 1251 such that the user is alerted on display 1222 to perform the first exercise, at step 930, and a prompt is issued to the user (step 940) to confirm they have received the alert and are starting the first exercise. Once the pain prevention module 1252 receives confirmation from the user (via keyboard and/or mouse 1218, for example), exercise data is passed (step 950) to exercise module 1256 which executes process 1100 (FIG. 11). Exercise module 1256 determines the exercise based on the exercise data, at step 1105, and then causes display of a description and video (or alternatively, animation) of the exercise (step 1110) via browser 1217 on display 1222, together with the number of repetitions or duration as specified in the exercise data. Exercise module 1256 then prompts the user to indicate whether or not they have completed the exercise (step 1120).

Once the user indicates (by mouse click or key press, for example) that they have completed the exercise, the module 1252 advances the schedule (step 960) to the next exercise, and this is repeated until the schedule is complete (step 970).

The schedule may run over a particular period during a day, for example during the time normally set aside for the user's lunch break, or may run over the entire course of a working day, for example, with long breaks between exercises.

Although the flow chart of FIG. 9 shows the schedule being executed sequentially in process 900 by the module 1252, alternative implementations are of course possible. For example, rather than prompting the user to perform an exercise and only advancing to the next step once an exercise is completed, module 1252 could simply generate an exercise schedule, and display the schedule (e.g., displaying the time and type of each exercise) on the user's home screen. In another alternative, the timing and/or type of exercise within a schedule could be user-editable.

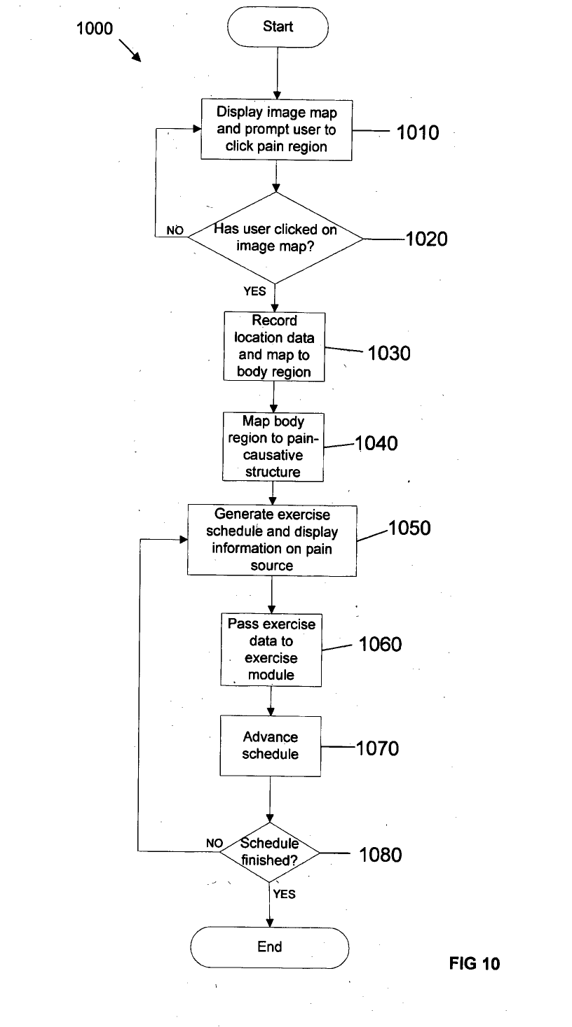

Returning to FIG. 8, if the user interface module 1251 receives a trigger (via an event in browser 1217) to indicate the user wishes to target a specific area (either for treatment or prevention purposes) at step 830, then at step 850, pain treatment module 1254 executes a pain treatment process 1000 (FIG. 10).

Module 1254 first causes display of an image map in browser 1217 and prompts the user to click on the image map at a body location they wish to target (step 1010). Referring to FIG. 7, an example of an image map 710 is shown in a schematic depiction of a screen shot 700. The image map 710 includes a picture of a human body 715, showing the locations of muscles and joints.

Once a mouse click event on image map 710 is received (step 1020), the module 1254 calculates location data, identifies (step 1030) the relevant body region based on the location data, and displays a zoomed view 720 of the selected region. In the example shown in FIG. 7, the user has clicked on the levator scapulae region.

The module 1254 may prompt the user to answer one or more clarification questions 722 regarding the type of pain in the selected region, and may provide an explanation 724 of the cause or causes of the pain and/or provide a link to an educational resource as mentioned above.

The module 1254 may perform a step 1040 of mapping the body region to a particular muscle or joint. In the case of direct pain, the body region may be the muscle or joint itself. In the case of referred pain, for example at the base of the skull, the mapping step 1040 may involve consulting a lookup table to identify the muscles involved. The mapping step 1040 may use data obtained from the answers to the clarification questions 722 in order to perform the mapping.

Once the relevant muscle or joint has been identified, the user may click on either the treatment and management exercise program area 726 of the screen, or the prevention program area 728. Once a mouse click event is recorded, the module 1254 determines exercise data (step 1050) corresponding to exercise data 727 or exercise data 729 to target the particular muscle or joint identified. The module 1254 then passes exercise data 727 or 729 to exercise module 1256 (step 1060), which proceeds as described above. The schedule is then advanced (step 1070) and the process repeated until all exercises are completed (step 1080).

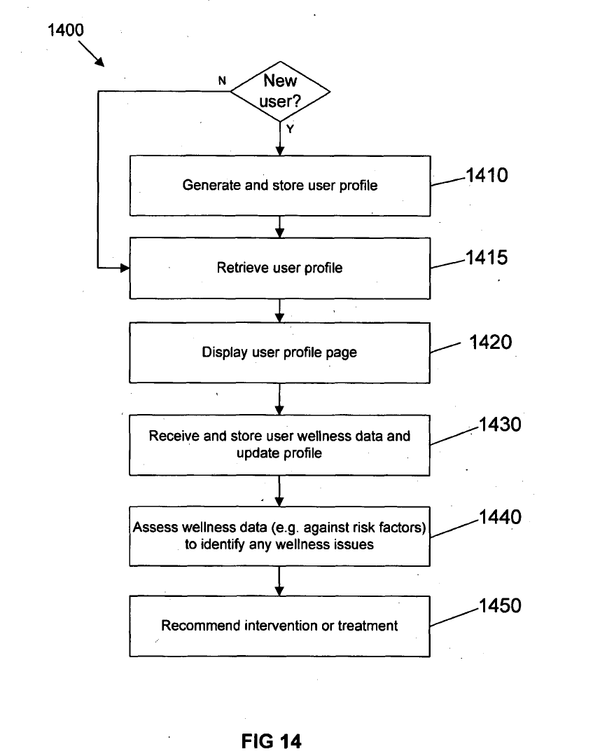

Referring now to FIG. 14, there is shown a flow chart for an embodiment of a wellness monitoring method 1400.

Wellness monitoring module 1260 cooperates with user interface module 1251 to display a login page in browser 1217, or in some embodiments, in a client application 1218 (e.g., a smartphone or tablet app). If the user is a new user, a user profile is generated and stored in database 1362 at step 1410. Otherwise, an existing user's profile is retrieved at step 1415. The user profile includes values (default values, in the case of a new user) for a plurality of wellness parameters.

As part of user profile generation step 1410, wellness monitoring module 1260 may generate, as some of the wellness parameters, one or more risk factors for the user. The risk factors may include, for example, one or more of the following: job description; psychological job requirements; job history; medical history; medical risk factors. At least some of the risk factors may be automatically generated based on data input by the user. For example, psychological job requirements may be automatically generated on the basis of job description. Values for the risk factors may be input by the user associated with the user profile, but preferably are input by a user with elevated access privileges, such as an administrator user or a health professional with suitably elevated privileges.

Wellness monitoring method 1400 then displays the user's profile page in browser 1217 or client application 1218, at step 1420. The profile page may include a display of information including historical values of one or more wellness parameters stored in the user's profile, thereby enabling the user to quickly identify any trends in those parameters.

At step 1430, wellness monitoring module 1260 causes display of a prompt for the user to enter values for one or more wellness parameters. The wellness parameters may include any or all of the wellness parameters mentioned above. The input may occur by one or more of: entering a numerical value, selecting a value on a visual analogue scale or a Likert scale, or making a selection from a drop-down list, set of radio buttons or the like. The numerical value(s) or selection(s) may correspond, for example, to a quantitative or qualitative measure of a particular wellness parameter for a particular period such as a working day.

Wellness monitoring module 1260 may also cause the user interface in browser 1217 or client application 1218 to provide for input of individual goals for the user (be they physical, psychological or professional). A goal may include a particular level or value for a particular wellness parameter that the user is seeking to achieve, for example, or may be a qualitative goal such as “achieve better posture generally” or “lower stress levels”.

Following data entry, the user's profile is updated and stored in database 1362.

At step 1440, wellness monitoring module 1260 assesses the stored values of at least one, preferably a plurality, of the wellness parameters in order to identify any wellness issues. The assessment may be of the wellness parameters per se. In other embodiments, the assessment may be carried out in light of one or more of risk factors for the user. In yet other embodiments, the assessment may be carried out in light of one or more individual goals of the user. If a plurality of wellness parameters is examined then a combination may be derived from the plurality in order to make a comparison between the combined wellness parameters and the risk factor(s).

Step 1440 may identify one or more wellness issues that need to be addressed for the user. If so, at step 1450, wellness monitoring module 1260 recommends an intervention, treatment or management program appropriate for the issue(s), and stores information relating to the recommendation in the user's profile in database 1362. For example, the wellness parameters assessed may include degree and/or region of pain and/or stiffness, whether considered in isolation or in combination with at least one other wellness parameter (e.g. stress level) and the intervention or treatment may include any of the pain prevention or pain treatment methods or exercises described above.

The recommendation may be made directly to the user and/or to another user of the system 1200, 1300, such as a health professional user or HR employee user whose profile is associated with that of the user. The wellness monitoring module 1260 may be configured to accept input from the health professional user or HR employee user regarding a rehabilitation or return-to-work program. The input may be used to generate exercise schedules, similar to those above, which are then stored in the user's profile. Alternatively, if exercise schedules are already stored, they may be modified (if appropriate) according to the input from the health professional user or HR employee user.

Not shown in FIG. 14, but also possible within the scope of the method, is monitoring of wellness of a plurality of users of the system of FIG. 13. An administrator module (not shown) of modules 1250 may include the facility to retrieve data from a plurality of user profiles, and to generate summaries of the wellness parameters for respective users so as to identify any wellness issues which may exist within the user base. In this way, wellness issues can be addressed on an organisation-wide basis.

The data may be stratified in a number of ways, including stratification by one or more of the following: job title, job description, a particular physical or psychological wellness parameter, a department within the organisation (e.g. sales, HR, finance). Some embodiments include temporal stratification of the data—for example, by particular periods such as Christmas or other major holidays, end of financial year, seasons (winter, summer etc.) and the like.

Embodiments of the method and system therefore involve creating an individualised vocational, medical, physical and psychological profile for users, whereby daily physical and psychological data are input into the system, which then provides recommendations to prevent physical injury and mental illness, optimise recovery or rehabilitation and improve wellness (physical and mental). Additional information can be input from health professionals or the user(s) to expand the user profile and data can then be collated for the employer or user to improve overall strategies.

Many modifications will be apparent to those skilled in the art without departing from the scope of the present invention.

The reference to any prior art in this specification is not, and should not be taken as, an acknowledgment or any form of suggestion that the prior art forms part of the common general knowledge in the field of endeavour to which this specification relates.

1. A method, executed by a computer, of treating or preventing musculo-skeletal pain in a person, including:
generating identification data representing sources of musculo-skeletal pain, said sources being associated with structures in the musculo-skeletal system; and
determining, based on said identification data, and providing exercise data representing one or more exercises to strengthen or loosen said structures.

2. A method according to claim 1, further including providing a user interface for a user to enter location data representative of one or more regions of the body.

3. A method according to claim 2, wherein the user interface includes an image map with a plurality of clickable or touch-sensitive areas corresponding to at least said regions;
and wherein said image map is used to generate said location data.

4. A method according to claim 2 or claim 3, wherein said location data are used to generate said identification data.

5. A method according to any one of the preceding claims, further including generating a schedule of exercises.

6. A method according to claim 5, further including triggering an alert to the person to perform the one or more exercises.

7. A method according to claim 5 or claim 6, wherein the schedule is user-editable.

8. A method according to any one of the preceding claims, wherein the exercises are selected from the group including: thoracic extension; reverse fly; pectoral stretch; hip flexor stretch; bow and arrow; cervical retraction; lumbar extension; combined protraction; and combinations thereof.

9. A computer-implemented method of wellness monitoring, including:
generating a user profile for a user, the user profile being associated with a plurality of wellness parameters for the user;
recording values for at least some of the wellness parameters at a succession of times; and
storing, in the user profile, the values of the wellness parameters at the succession of times.

10. A method according to claim 9, further including recommending, on the basis of the values of the wellness parameters, a preventative or remedial action.

11. A method according to claim 10, wherein the preventative or remedial action includes course of treatment and/or exercise.

12. A method according to any one of claims 9 to 11, including generating a plurality of user profiles associated with respective sets of wellness parameters for respective users, and recording values for the wellness parameters for each respective user.

13. A method according to any one of claims 9 to 12, including displaying wellness data generated from the values of the wellness parameters.

14. A method according to any one of claims 9 to 13, including summarising the values of the wellness parameters.

15. A method according to any one of claims 9 to 14, wherein the wellness parameters include at least one risk factor.

16. A method according to claim 15, including recommending, on the basis of the at least one risk factor in combination with at least one other wellness parameter, a course of treatment and/or exercise.

17. A wellness monitoring system, including:
means for generating a user profile for a user, the user profile being associated with a plurality of wellness parameters for the user;
means for recording values for at least some of the wellness parameters at a succession of times; and
means for storing, in the user profile, the values of the wellness parameters at the succession of times.

18. An exercise apparatus for treating or preventing musculo-skeletal pain in a person, including:
a body having a curved upper surface,
wherein the curved upper surface includes a first portion shaped to support an upper back region of the person, and a second portion shaped to support a lower back region of the person.

19. An exercise apparatus according to claim 18, wherein the first portion and the second portion are joined by a smooth transition region.

20. An exercise apparatus according to claim 18 or claim 19, further including one or more grooves for placement of a foot, knee, forehead or spine of the person.

21. An exercise apparatus according to any one of claims 18 to 20, further including a cavity for storage of one or more accessories for use with the exercise apparatus.

22. A method according to any one of claims 1 to 8, wherein at least one of the exercises uses an apparatus according to any one of claims 18 to 21.

23. A computer program product, including a computer-readable medium having instructions stored thereon for controlling at least one processor, wherein the instructions include code for implementing the method of any one of claims 1 to 16 or claim 22.

24. A system for treating or preventing musculo-skeletal pain in a person, including the computer program product of claim 23.

25. A system according to claim 24, further including the apparatus of any one of claims 18 to 21.
